(19) United States
(12) Patent Application Publication
(10) Pub. No.: US 2012/0110239 A1
(43) Pub. Date: May 3, 2012

(54) Causing Related Data to be Written Together to Non-Volatile, Solid State Memory

(75) Inventors: Ryan J. Goss, Lakeville, MN (US); Bernardo Rub, Sudbury, MA (US)

(73) Assignee: SEAGATE TECHNOLOGY LLC, Scotts Valley, CA (US)

(21) Appl. No.: 12/913,408

(22) Filed: Oct. 27, 2010

(51) Int. Cl. G06F 12/00; G06F 12/10; G06F 12/02

(52) U.S. Cl. 711/103; 711/209; 711/E12.001; 711/E12.008; 711/E12.058

(57) ABSTRACT

A first write request that is associated with a first logical address is received via a collection of write requests targeted to a non-volatile, solid state memory. It is determined whether the logical address is related to logical addresses of one or more other write requests of the collection that are not proximately ordered with the first write request in the collection. In response to this determination, the first write request and the one or more other write requests are written together to the memory.

### SUMMARY

Various embodiments of the present invention are generally directed to methods, systems, and apparatuses that facilitate causing data to be written together to non-volatile, solid state memory. In one embodiment, a method, apparatus, system, and/or computer readable medium may facilitate receiving, via a collection of write requests targeted to a non-volatile, solid-state memory, a first write request that is associated with a first logical address. It is determined that the logical address is related to logical addresses of one or more other write requests of the collection that are not proximately ordered with the first write request in the collection. The first write request and the one or more other write requests are caused to be written together to the memory.

In some arrangements, determining that the logical address is related to the logical addresses of the one or more other write requests of the collection may involve determining that the logical address is sequentially related to the logical addresses of the one or more other write requests of the collection. In other arrangements, each of a plurality of memory units is associated with respective ranges of logical addresses, and if the first logical address corresponds to a selected one of the ranges of logical addresses, the first write request and the one or more other write requests may be assigned to be written to a selected memory unit associated with the selected one of the ranges. Otherwise the first write request and the one or more other write requests may be assigned to be written to a targeted memory unit using alternate criteria. In such a case, the collection of write requests may be searched for the one or more other write requests in response to assigning the first write request to be written to the selected memory unit.

In another arrangement, the collection of write requests may include a plurality of sequential streams of data. In such a case, mapping units may be maintained between logical addresses of the sequential streams and physical addresses associated with targeted memory units in which the sequential streams are stored. In this case, the mapping units may include at least a start logical address and sequence length of an associated one of the sequential streams and a start logical address of a targeted memory unit in which the associated one sequential stream is stored. Further in this case, the mapping units may be used for servicing access requests for the targeted memory units in response to the logical addresses of the sequential streams being associated with the access requests.

In yet another arrangement, the collection may include a cache, and the first write request may be received in response to a cache policy trigger that causes data of the first write request to be launched from the cache to the memory. In another arrangement, causing the first write request and the one or more other write requests to be written together to the memory may include causing the first write request and the one or more other write requests to be written sequentially to the memory.

In another embodiment, a method, apparatus, system, and/or computer readable medium may associate each of a plurality of units of memory with respective ranges of logical addresses. A first write request that is associated with a first logical address is received via a cache. The cache includes one or more sequential streams of data targeted for writing to a non-volatile, solid state memory. It is determined that the first logical address is sequentially related to logical addresses of one or more other write requests of the cache that are not proximately ordered with the first write request in the cache. It is also determined whether any of the first logical address and the logical addresses of the one or more other write requests correspond to a selected one of the ranges of logical addresses. The first write request and the one or more other write requests are caused, in response thereto, to be written sequentially to a unit of the memory associated with the selected one of the ranges of logical addresses.

In one arrangement, mapping units may be maintained between logical addresses of the sequential streams and physical addresses associated with the units of the memory in which the sequential streams are stored. In such a case, the mapping units include at least a start logical address and sequence length of an associated one of the sequential streams and a start logical address of a targeted unit of the memory in which the associated one sequential stream is stored. Also, the mapping units in such a case can be used for servicing access requests for the targeted unit of memory in response to the logical addresses of the sequential streams being associated with the access requests. In another configuration, the first write request is received in response to a cache policy trigger that causes data of the first write request to be launched from the cache to the memory.

In other arrangements, one or more page builder modules are each associated with a) one of the logical address ranges and b) at least one page of the memory. Each of the page builders independently determine that any of the first logical address and the logical addresses of the one or more other write requests correspond to the associated one logical address range, and if so cause the first write request and the one or more other write requests to be written sequentially to the associated at least one page. The page builder modules may include a plurality of page builder modules operating in parallel.

These and other features and aspects of various embodiments can be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a block diagram illustrating the segregation of different data streams into separate pages of memory according to an example embodiment of the invention;

FIG. 2 is a component diagram of a system according to an example embodiment of the invention;

FIGS. 3 and 4 are flowcharts illustrating procedures of writing to logical addresses according to embodiments of the invention;

FIG. 5 is a flowchart illustrating a modified cache policy according to an example embodiment of the invention;

FIG. 6 is a flowchart illustrating a procedure for identifying streams in a cache according to an example embodiment of the invention;

FIG. 7 is a flowchart illustrating a procedure for combining identified streams into subsequent pages of memory; and

FIG. 8 is a block diagram of an apparatus/system according to an example embodiment of the invention.

### DETAILED DESCRIPTION

The present disclosure relates to techniques for writing multiple sequential streams to a data storage device. Many modern computing devices are capable of executing multiple computing tasks simultaneously. For example, multi-core and multi-processor computer systems can operate on different sets of instructions in parallel. This enables, for example, running multiple programs/processes in parallel and/or breaking down a single program into separate tasks (e.g., threads) and executing those tasks in parallel on different processors and cores.

This parallelism may also extend to input/output (I/O) operations of a computing device. For example, multiple processes may attempt to simultaneously read/write data to a non-volatile data storage device. While small read/write tasks may be individually scheduled without significantly impacting collective performance, the same may not be true when the data to be read/written is relatively large. For example, some processes may need to read/write large files as contiguous streams of data.

A computing architecture may have a number of provisions to deal with simultaneous data streams without unduly impacting performance of the processes that utilize those streams. For example, the I/O busses and/or storage devices may be able to process multiple channels of data in parallel. In other situations, the data from multiple streams may be interleaved into a single channel. In this latter case, the net data transfer rate of each stream may be lowered, but the processes relying on those streams need not be stalled waiting for I/O access.

The data storage device itself may also have provisions for dealing with large, contiguous streams of data. For example, devices such as hard drives and solid state drives (SSDs) may exhibit optimal sequential read/write speeds for large data blocks if the data blocks are stored contiguously in the storage media. In the case of conventional hard drives, data transfer rates can be optimized if the read/write head does not need to randomly seek (e.g., move relatively long distances radially) while performing the data transfer operation. Therefore a hard drive may be able to achieve near optimal data transfer speeds when the data is stored in physically proximate sectors on the media.

Solid state drives do not have a moving read/write head, but still may exhibit improved sequential data access performance if data is stored sequentially in the physical media, e.g., pages of flash memory. This is due in part to the minimum page sizes that can be written or read from the drive in a single operation. For example, a flash memory device (e.g., SSD) may include a number of flash dies used for persistent data storage. The individual dies may be partitioned into blocks, which may further be divided into a number of pages that represent the smallest portion of data that can be individually read from and written to (or “programmed” in flash memory parlance). The page sizes of flash memory may vary depending on the hardware, although for purposes of the present discussion page sizes may be considered to be on the order of 8 KB to 16 KB. Some devices may implement multiple-plane operation within the flash that enables two or more pages to being acted upon simultaneously. In such a case, data is read and written at a size that is larger than a single physical page, e.g., the physical page size multiplied by an integer representing the number of planes.

In an SSD and similar devices, the single-plane or multiple-plane page sizes may be larger than a unit of access used by the host, e.g., 4 KB. This raises the possibility that a page read from flash memory may contain more data than requested by the host. For example, a host may have stored to a flash device a 32 KB block of data using six consecutive logical block addresses (LBAs) that each reference a 4 KB block of data. If the flash device is a dual-plane device with 16 KB page sizes, the minimum amount of data returned from a single read operation would be 32 KB. However, if this 32 KB of data corresponding to the six LBAs were split up (e.g., interleaved with other data) and written to two different dual-plane pages, then this would require reading 64 KB of data from the flash to read the 32 KB of requested data. The other 32 KB of data read during this operation may be empty, invalid, or associated with other streams/LBAs, etc., and so would often be thrown away.

Systems that apply compression may further magnify the problem of reading unrelated when combined in a sub-optimal manner. One of the benefits of compression is to enable faster writing and reading of data, but if the data is not packed with other related (e.g., sequential) data, then the benefit of compression may be negated, and the problem possibly even made worse. It should also be noted that the media storage of logical data will not always fit evenly within a physical page or even dual-page. In systems applying compressing, the non-deterministically sized data may often result in a single logical element spanning across at least two or more physical elements. When the data is not packed efficiently this may further magnify the problem. For example, for a single host transfer of a 4 KB block of compressed data, the back-end could end up reading 32 KB (2×16 KB), so ⅞ of the data is thrown away.

As will be discussed in greater detail below, one way of improving read performance in such a case is to ensure that data is stored to fill up the memory pages with, as much as possible, sequentially ordered (or otherwise related) data, e.g., data belonging to a single stream or other contiguous data structure. In the example given above, this would involve ensuring that the 32 KB data is stored in a single 32 KB page, even if there was some separation of the data stream as it was received at the storage device. This may generally involve recognizing and segregating different streams of data into separate pages of a memory device to enhance performance.

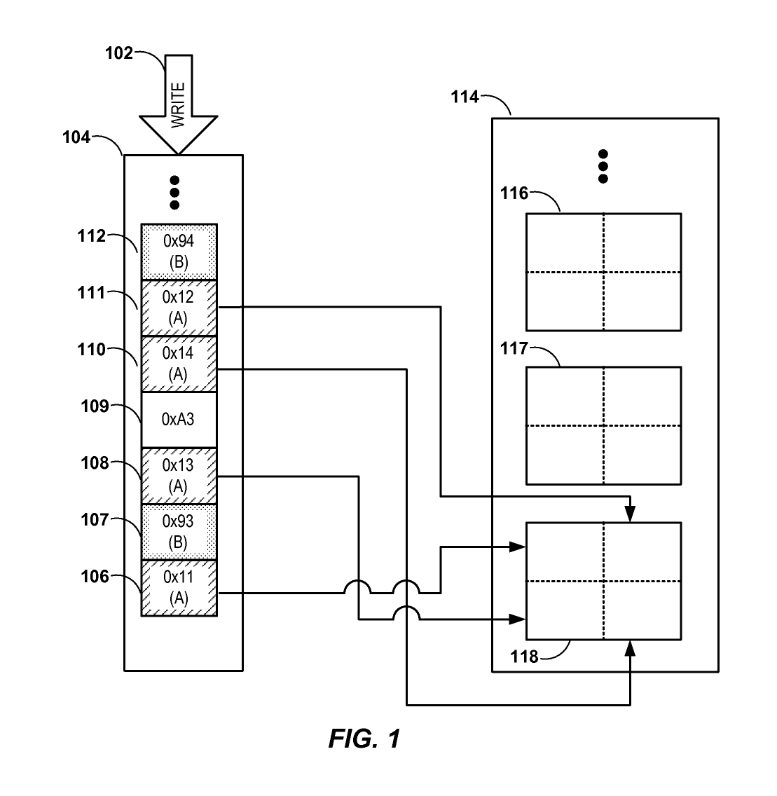

In reference now to FIG. 1, a block diagram illustrates the segregation of different data streams into separate pages of memory according to an example embodiment of the invention. A storage device (e.g., SSD) processes incoming write data 102 by placing incoming data into a collection 104. This collection 104 may be configured as a cache, buffer, array, queue, and/or any other data/hardware arrangement known in the art that is suitable for such a purpose. The system may include multiple such collections 104 and may process multiple data inputs 102 simultaneously.

The data inputs 102 may be received from an external source such as a host that is writing files to a non-volatile, solid-state, data storage device. The data inputs 102 may also originate from within the data storage device, e.g., invoked by internal processes such as garbage collection. The need for garbage collection may arise because non-volatile solid state memory devices may not be able to directly overwrite changed data, but may need to first perform an erase operation on the targeted cells before a new value is written. These erasures can be costly in terms of computing/power resources, and so instead of directly overwriting data, the device may write changed data to a new, already-erased, location, change the logical-to-physical address mappings, and mark the old location as invalid.

At some point, the device may invoke garbage collection in order to recover pages/portions of memory marked as invalid. Garbage collection may be performed on blocks of data that encompass multiple pages, and so if any data in the erasure block is still valid, it needs to first be moved elsewhere, and the logical-to-physical address mappings are changed appropriately. After this, the whole block can be erased and the pages within the erased block can be made available for programming. As garbage collection may involve writing data from one part of a storage device to another, garbage collection (and similar internal operations) may also take advantage of the identification of related data in a collection 104 as described herein, such that the related data can be written together in targeted units of memory.

For purposes of the present discussion, it may be assumed that data in the collection 104 contains elements that belong to different data streams but that may not be arranged sequentially (in terms of logical addresses) within the collection 104. The illustrated collection includes elements 106-112 that may include both a logical address and data corresponding to the smallest size of data that may be written via input 102. The logical addresses (which are represented in the figures as hexadecimal values within each element 106-112) may include any address or annotation used by the host (or intermediary agents) for referencing data independently of physical addresses used by the media.

While terms such as logical address, logical block address, LBA, etc., may have a specific meaning in various fields of the computer arts, the term as used herein may refer generally to any type or combination of one or more logical sectors of data. As such, these terms are not meant to be limiting to any specific form of data, but rather may include any indicia of conventional significance that identifying some data storage element, whether that storage originates from a host system or internally to the storage system itself.

In the data collection 104, the data stored in each element 106-112 is scheduled to be written to physical memory 114, here shown including pages 116-118. By way of example, each page 116-118 is capable of storing four logically addressed elements 106-112, where page sizes and logically addressed element sizes are treated as constant. The data may be read by default from one point of the collection 104, e.g., the end of collection 104 where element 106 is located. The ordering of elements 116-118 in the collection 104 may be determined dynamically, e.g., based a least recently used (LRU) algorithm on a cache.

Regardless of how the collection 104 is ordered, at least some elements 106 that are related by logical address are non-proximately ordered within the collection 104. In this context, “proximity” at least refers to a sequential order in which the elements 106 would be removed from the collection 104 by default, and not necessarily to any logical or physical proximity of elements 106 as currently stored within the collection 104. In some cases these types of proximities may correspond, however in other cases it is possible for a collection to store related logical addresses in a contiguous buffer/memory segment, yet order them for removal from the collection in a non-proximate (e.g., discontinuous) order.

In the illustrated elements 106-112, different shading is used to indicate elements that are part of different streams, and these streams may also evidenced by the use of sequential logical addresses. Thus elements 106, 108, 110, and 111 are part of Stream A with logical addresses 0x11-0x14, elements 107, 112 are part of Stream B with logical addresses 0x93-0x94, etc. It should be noted that, in this example, there need be no other indicators provided to the storage logic that describes the streams (e.g., communicates the existence and/or composition of the streams) other than sequential logical addresses. Nor need there be provided (e.g., embedded within the data elements 106-112) indicators that provide evidence of beginnings, ends, lengths, durations, etc. of the respective streams. However, the present embodiments may be adapted to utilize such indicators, which may be of use in some situations (e.g., reserving proportionate amounts of physical memory in advance for streams). Or, in alternate configurations, there may be some indications that can used to determine elements 106-112 are related instead of sequential logical addresses. Such indicators may include, but are not limited to, stream identifiers used by a host or internal component, relations formed due to internal operations such as garbage collection, wear leveling, etc.

If the bottom elements 106-109 are removed from the collection 104 and stored in page 118, only two elements 106, 108 from Stream A would be in page 118. The other two 110, 111 elements of Stream A would then end up in page 117 when elements 110-112 (and possibly one more) are written. Thus, a subsequent read of Stream A would require reading from both pages 117, 118 in order to read logical addresses 0x11-0x14. As should be apparent in this illustration, this would require reading twice as much data as needed, and likely discarding half of that data.

In one embodiment of the invention, multiple pages of the memory 114 may be reserved and made ready to store incoming data. If it is determined that a particular page, e.g., page 118, is associated with at least one logical address, e.g., 0x11, elements within the next (or previous) n-logical addresses are the optimal choice for additional storage to the page. Thus when it is determined that element 106 is or will be associated with page 118, some portion of the collection may be searched to determine whether any other elements 107-112 are within one of ranges 0x11+n, 0x11−n, or 0x11±n, depending on the specific implementation. In this case, elements 108, 110, and 111 fall within that range, and so are selected for storage in page 118 as indicated by the lines connecting elements 106, 108, 110, and 111 with page 118.

Generally, in various embodiments described herein, multiple pages may be reserved to store incoming data. At some point, some selected pages (and/or groups of pages) may be associated with one or more logical address ranges. Any additional available data for writing (e.g., within a buffer, cache, FIFO queue, etc.) within the logical address ranges will be written to the selected pages. If further data is presented for writing that does not fall within any of the ranges (e.g., non-sequential data), then the optimal choice may be that the further data is routed to a page (and/or group of pages) reserved for that purpose.

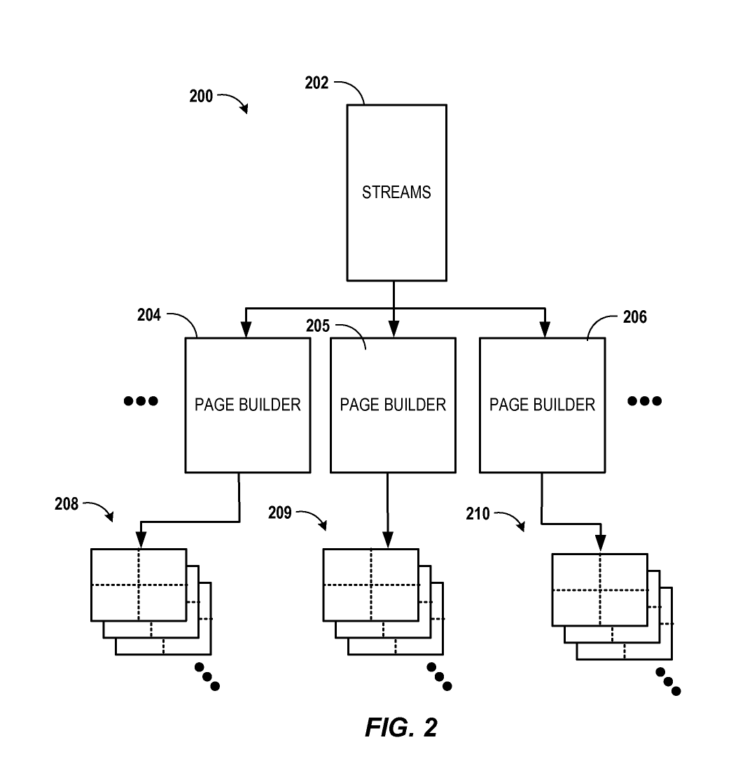

In reference now to FIG. 2, a block diagram illustrates components of a system 200 according to an example embodiment of the invention. Incoming data streams 202 may be accessible via a cache, buffer, or other data structure. A plurality of page builders 204-206 may each be associated with one or more dedicated pages 208-210, respectively, of non-volatile memory. The page builders 204-206 may be any combination of controller hardware and software that can read the combined input data 202, determine if particular data elements from the input 202 belong to a stream of interest, and assign any such stream data to be written to the associated pages 208-210.

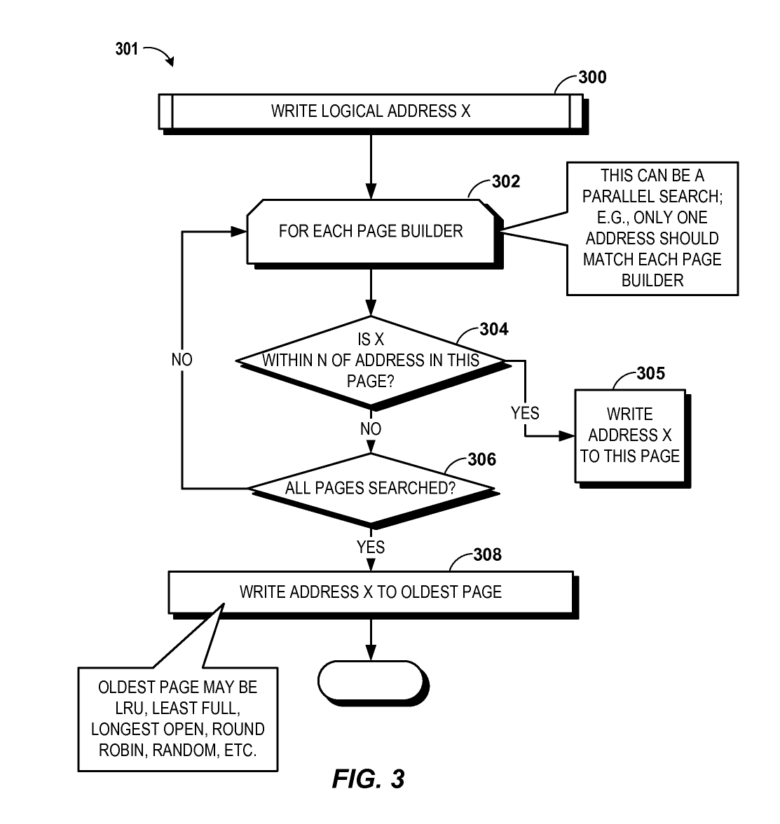

In the discussion that follows, reference may be made to page builders, such as builder 204 shown in FIG. 2. For example, in FIG. 3, a flowchart illustrates a procedure that may be implemented by the system 200 and equivalents thereof according to an embodiment of the invention. It will be appreciated that the system 200, its illustrated structure, and accompanying functional descriptions are provided for purposes of illustration, and not of limitation, and similar functionality may be obtained through different structures/paradigms (e.g., a monolithic program that maps streams 202 to pages 208-210).

In reference now to FIG. 3, a procedure 301 is triggered when an input source writes 300 to a logical address X. Each of the page builders is selected 302 (e.g., may be selected in any combination of series and parallel operations) and the selected page builder determines 304 whether address X is within the range of the page builder. If so, the address X is written 305 to a page associated with the page builder. If it is determined 306 all pages of the page builders have been searched, and no match has been found, the data of address X may be written 308 to a page set aside for this purpose. e.g., the oldest page targeted for writing.

In some situations, a page builder and associated pages may not yet be associated with any logical address. In such a case the writing operation 308 may also serve to set up such an association, and instantiate or otherwise prepare a page builder to detect data for a particular address range. Once a page is filled, and/or the opportunity to put data into other pages has been exceeded, the one of the page builders and/or associated pages may allow other non-stream data to be written to the pages. In a pure random workload this packing method may create a “round-robin” filling of the targeted pages, which may also be beneficial for the distribution of writes across a large portion of the array (e.g., parallelism).

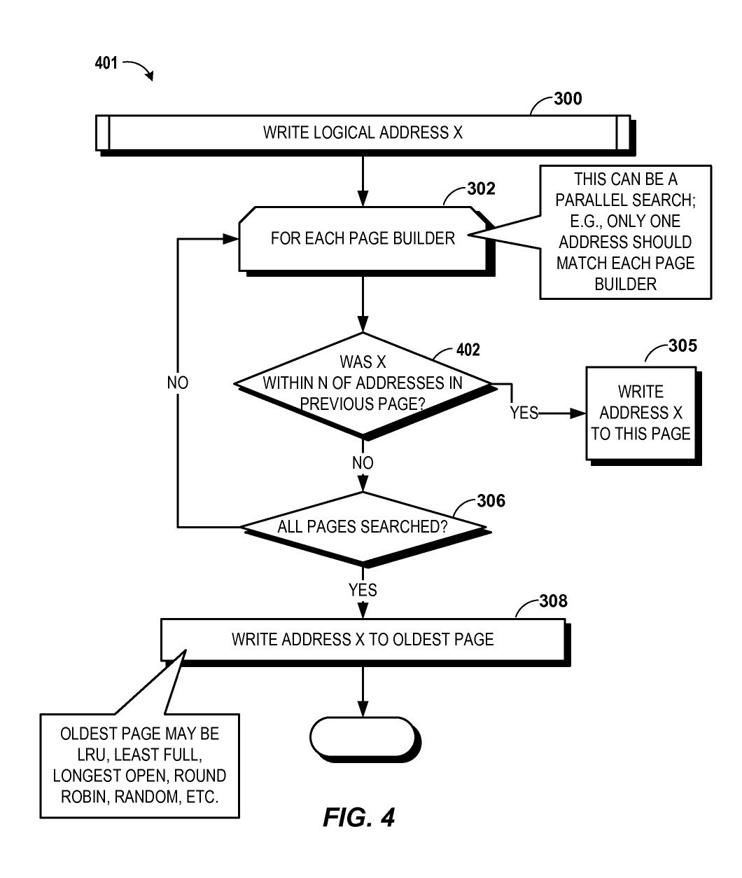

In some arrangements, once a page has been filled with sequential data, the associated page builder may maintain a preference to continue filling additional pages with subsequent sequential data. This will enable multiple pages of data in physically sequential order to represent logically sequential data. This concept is shown in FIG. 4, which includes another flowchart of procedure 400 with functional blocks 300, 302, 305, 306, and 308 analogous to those shown and described in FIG. 3. The procedure 400 includes a check 402 to see if a currently written logical address X is within some range of another page already filled by the currently selected page builder.

The above-described preferences for choosing subsequent sequential data may also have some practical limit so as to not starve the opportunity for other data to be filled into the available page. In such a case, all the starvation preferences can be made be configurable and dynamic, and even proactively learning optimal values throughout the lifetime of the system. For example, if there are N page builders in the system, N−1 can be dedicated to different sequential streams and the last builder can remain available for other random data to prevent starvation. At any time there may be zero to N page builders assigned to writing sequential data, and this number may dynamically change based on current conditions, e.g., number of detected streams.

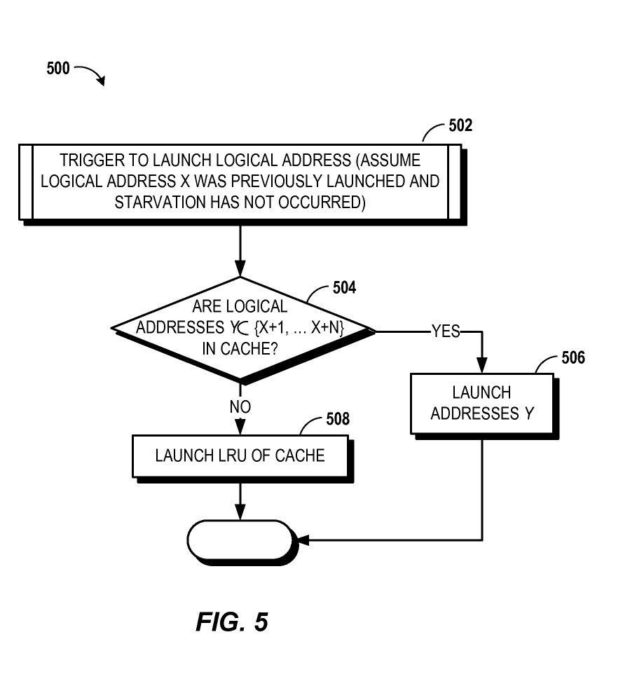

As discussed above with reference to FIGS. 1 and 2, the non-volatile system may include a cache that buffers data as it is being written to the non-volatile media. Such a cache may utilize a default policy for launching (e.g., removing from the cache and writing to non-volatile storage), such as least recently used (LRU). However this policy may be adapted to favor sequential writes where feasible. This is illustrated in the flowchart 500 of FIG. 5, which illustrates a modified cache policy according to an example embodiment of the invention.

At block 502, a trigger is detected for launching a logical address X. For example, an element with logical address X is in the cache and it may be currently in the LRU position. When this occurs, a determination 504 is made as to whether there are additional addresses within some range of X. In this example, these addresses are denoted as a subset Y. If Y is not empty, the addresses in Y are also launched 506, otherwise the next LRU element may be launched 508.

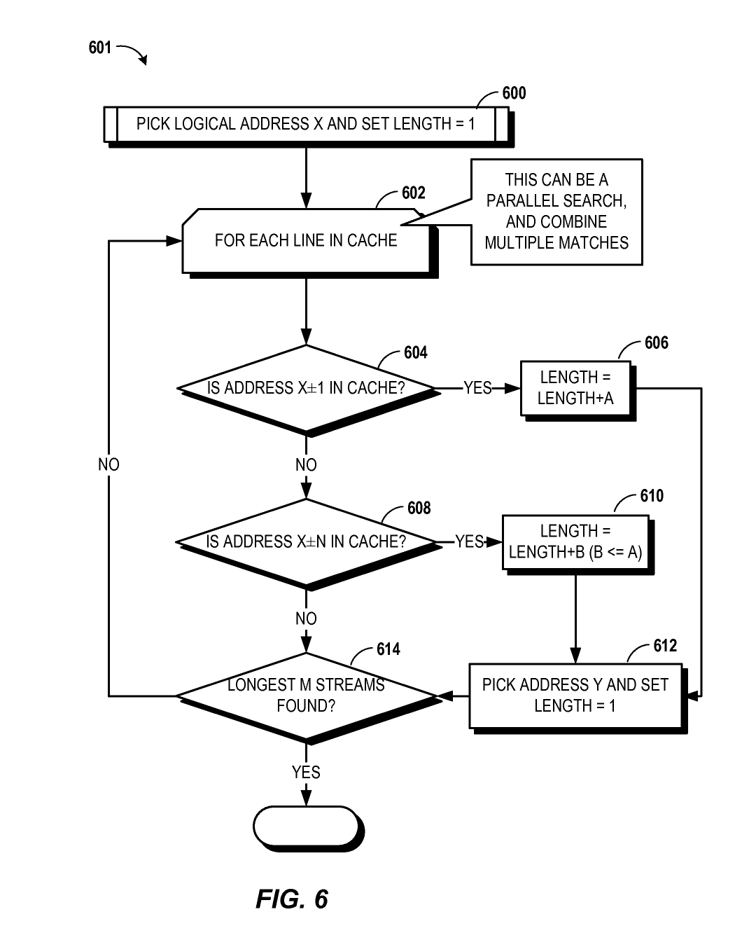

A system as described herein may implement a fairness scheme for the cache such that the LRU position does not get held off indefinitely as to stall other non-sequential or multiple sequential streams. The data within the cache (or even data to be entered into the cache or predicted to be entering the cache in the future) can be used to identify the number of streams and the length of each stream. The length of the stream can be defined by analyzing the number of logical addresses in consecutive order, which is shown by way of example in FIG. 6.

In FIG. 6, a flowchart illustrates a procedure 601 for identifying streams in a cache according to an example embodiment of the invention. A first logical address X is selected from the cache and the stream length is set to one. A loop 602 iterates through each line of the cache, and loops 602 of this type may be performed in parallel. If it is determined 604 that address X±1 is in the cache, the stream length is incremented 606 by a value A. If this next address is not found, another test 608 may determine whether some address offset N is in the cache, and if so the length may also be incremented 610 by some value, in this case a lower value than for those found in blocks 504, 506. This may give streams in a “pure sequential” order a higher precedence than a stream that has address X and address X+M in the cache, where M>1 (e.g., “skip sequential” order). Lowering precedence for “skip sequential” streams may facilitate later coalescing the missing logical addresses from the stream as the cache is reordered.

It will be appreciated that multiple additional tests may be carried out between blocks 504 and 508, e.g., using offsets between 1 and N. These additional tests may also determine some combination of “pure sequential” and “skip sequential” streams, and calculate lengths appropriately. After address X has been analyzed, a similar procedure may occur for another address Y as indicated in block 612. After all logical addresses of interest have been analyzed, the procedure will have determined 614 the longest M streams and will complete.

The cache may launch a streambased on the length and precedence values, where the longest “pure sequential” stream is launched first, and then subsequent streams are launched secondary. For example, the longest K streams can be managed and launched simultaneously to K page builders in the system. When combined with the approach described above for reserving a page builder for prevention of starvation the LRU items in the cache that are not a part of the longest K streams will be launched to the remaining page builder. In some arrangements, if the largest K streams are assigned at time T, and at some later time T+I there are a different set of K largest streams the system can stop processing the current stream which has been depleted and can begin processing the new stream that has more elements. This reassignment of the largest K streams can have a hysteresis where the cache would have a preference to fully deplete an existing stream prior to switching to a new stream. There can be a dynamically assigned trigger point where the difference in length (or precedence) can cause the cache to decide to stop launching an existing stream and switch to one of the new streams. If the length of the current stream being launched is small enough, then launching of the current stream can be fully completed, so as to complete the outstanding commands that are nearly finished.

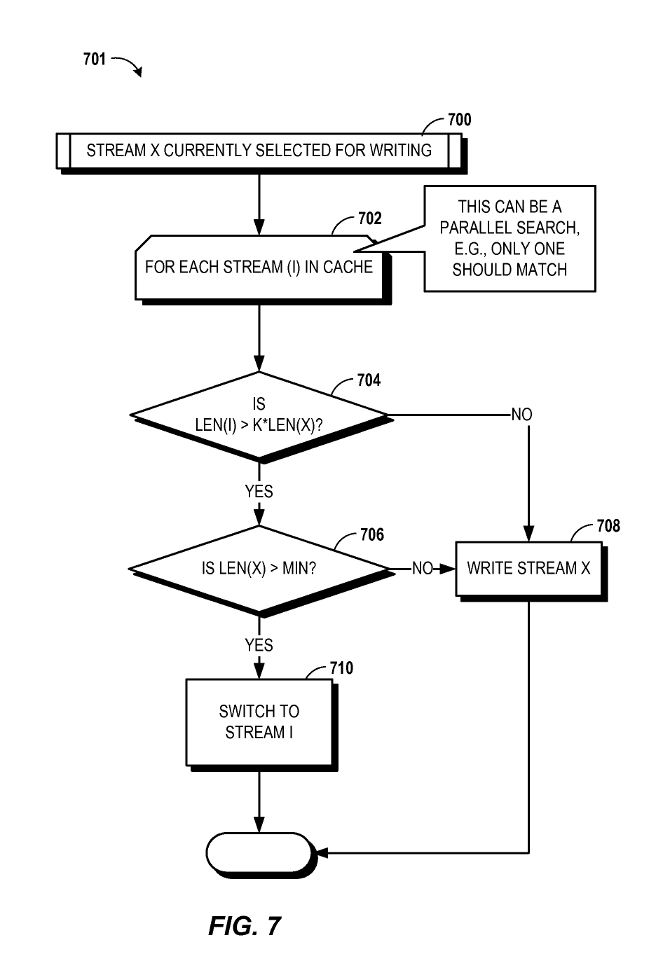

In reference now to FIG. 7, a flowchart illustrates a procedure 701 where sequential streams determined from FIG. 6 may be combined into subsequent pages. When stream X is selected for writing, a search 702 may occur for other streams in the cache. If it is determined 704 that stream X is some factor larger than other streams, or if it is determined that 706 the length of stream X is less than a minimum value, then stream X is written 708. Otherwise stream I is selected 710, and the procedure may be repeated to determine whether to write stream I instead.

There may be benefits to switching streams while one or more of the streams are being written, such as servicing a larger amount of host demand. There may also be benefits of remaining on the current stream, such as returning command completion status sooner and reducing latency, as well as the possibility that there will be less intermixing of streams within the pages. For example, an internal process such as garbage collection may be less sensitive as to latency/delay, in such case may favor writing streams to completion as much as possible. In order to provide different performance characteristics, the data in the cache may be proactively directed towards a specific page builder which can be pre-determined as an optimal candidate for sequential segregation based on some metrics. This can be accomplished either as data enters the cache, or can be done by some processing of the data once it has arrived in the cache prior to launch.

The system may also be configured such that the segregation of sequential data within a page facilitates simplifying the metadata used to describe such data. For example, rather than storing a location for each logical address, it may be possible to use compressed metadata in a start and sequence length format. For example, a mapping metadata unit may include a logical address portion in the form of {start_logical_address: sequence_length} that is mapped to a physical address portion in the form of {start_physical_address}. The physical address portion may also include a sequence length. However, in some cases (e.g., where there is a fixed relationship between logical address block sizes and page sizes) such physical sequence data may be redundant and therefore can be safely left out. For very large sequences, this may represent a significant decrease in memory needed to store the metadata. This reduction in metadata may also result in fewer updates of the metadata. This causes less write-amplification due to the metadata management, and therefore may result in higher performance.

In some known systems, the processing system may have to individually schedule each page operation, and may often be reading across multiple non-sequential physical pages to read a sequential stream. In a system according to the embodiments described herein, it may also be possible to use compressed metadata (or normal metadata) to describe sequential data that spans across multiple physically sequential pages. In such a case, read operations could be proactively scheduled (e.g., read-ahead). This would reduce the burden on the processing system to create scheduling opportunities for the data.

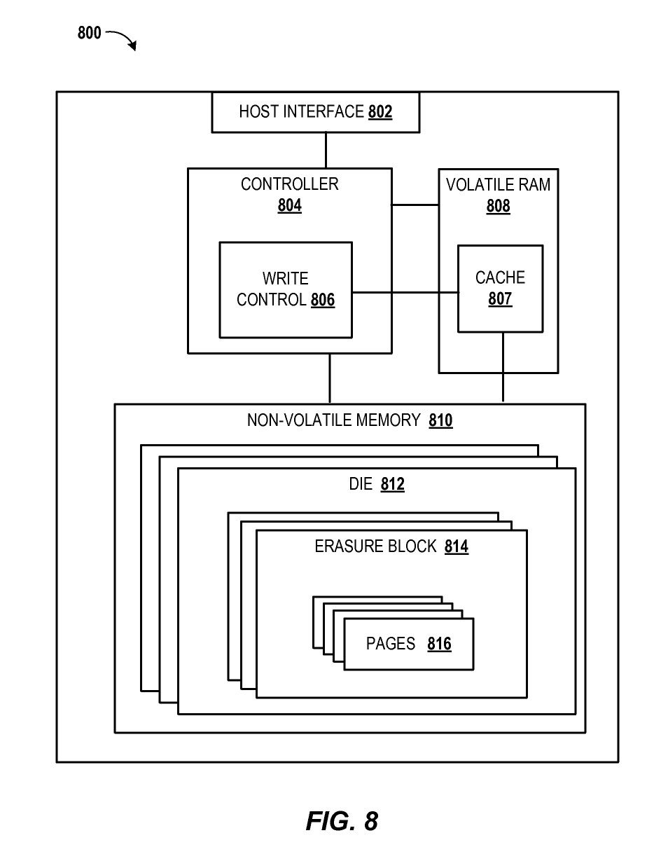

In reference now to FIG. 8, a block diagram illustrates an apparatus/system 800 which may incorporate features of the present invention described herein. The apparatus 800 may include any manner of persistent storage device, including a solid-state drive (SSD), thumb drive, memory card, embedded device storage, etc. A host interface 802 may facilitate communications between the apparatus 800 and other devices, e.g., a computer. For example, the apparatus 800 may be configured as an SSD, in which case the interface 802 may be compatible with standard hard drive data interfaces, such as Serial Advanced Technology Attachment (SATA), Small Computer System Interface (SCSI), Integrated Device Electronics (IDE), etc.

The apparatus 800 includes one or more controllers 804, which may include general- or special-purpose processors that perform operations of the apparatus. The controller 804 may include any combination of microprocessors, digital signal processor (DSPs), application specific integrated circuits (ASICs), field programmable gate arrays (FPGAs), or other equivalent integrated or discrete logic circuitry suitable for performing the various functions described herein. Among the functions provided by the controller 804 are that of write control, which is represented here by functional module 806. The module 806 may be implemented using any combination of hardware, software, and firmware. The controller 804 may use volatile random-access memory (RAM) 808 during operations. The RAM 808 may be used, among other things, to cache data read from or written to non-volatile memory 810, map logical to physical addresses, and store other operational data used by the controller 804 and other components of the apparatus 800.

The non-volatile memory 810 includes the circuitry used to persistently store both user data and other data managed internally by apparatus 800. The non-volatile memory 810 may include one or more non-volatile, solid state memory dies 812, which individually contain a portion of the total storage capacity of the apparatus 800. The dies 812 may be stacked to lower costs. For example, two 8-gigabit dies may be stacked to form a 16-gigabit die at a lower cost than using a single, monolithic 16-gigabit die. In such a case, the resulting 16-gigabit die, whether stacked or monolithic, may be used alone to form a 2-gigabyte (GB) drive, or assembled with multiple others in the memory 810 to form higher capacity drives. The dies 812 may be flash memory dies, or some other form of non-volatile, solid state memory.

The memory contained within individual dies 812 may be further partitioned into blocks, here annotated as erasure blocks/units 814. The erasure blocks 814 represent the smallest individually erasable portions of memory 810. The erasure blocks 814 in turn include a number of pages 816 that represent the smallest portion of data that can be individually programmed or read. In a NAND configuration, for example, the page sizes may range from 512 bytes to 4 kilobytes (KB), and the erasure block sizes may range from 16 KB to 512 KB. Further, the pages 816 may be in a multi-plane configuration, such that a single read operation retrieves data from two or more pages 816 at once, with corresponding increase in data read in response to the operations. It will be appreciated that the present invention is independent of any particular size of the pages 816 and blocks 814, and the concepts described herein may be equally applicable to smaller or larger data unit sizes.

It should be appreciated that an end user of the apparatus 800 (e.g., host computer) may deal with data structures that are smaller than the size of individual pages 816. Accordingly, the controller 804 may buffer data in the volatile RAM 808 (e.g., in cache 807) until enough data is available to program one or more pages 816. The controller 804 may also maintain mappings of logical block address (LBAs) to physical addresses in the volatile RAM 808, as these mappings may, in some cases, may be subject to frequent changes based on a current level of write activity.

As part of this mapping between logical and physical addresses, the controller 804 receives, via a collection of write requests (e.g., cache 807) targeted to non-volatile memory 810, a first write request that is associated with a first logical address. The controller determines 810 that the logical address is related (e.g., sequentially) to logical addresses of one or more other write requests of the collection that are not proximate to the first write request in the collection. The controller 804 causes the first write request and the one or more other write requests to be written together (e.g., sequentially) to the flash memory 810. If these logical addresses are later read as a group from the flash memory 810, there will likely be less data discarded than if the logical addresses were mapped to the physical addresses using some other criteria (e.g., pure cache LRU algorithm).

The controller 804 may perform these operations in parallel and/or in serial. For example, the write control module 806 may include a plurality of page builder modules each associated with at least one physical address of pages 816 and logical address, the latter being associated with a stream of data targeted for writing to the memory 810. The page builder modules may individually search through the cache 807 (or other collection) to find sequential logical addresses within some range of their associated logical address. In such a case, the page builder modules can attempt to ensure data from a particular stream is written sequentially (either pure sequential or skip sequential) within their associated physical pages 816.

The foregoing description of the example embodiments of the invention has been presented for the purposes of illustration and description. It is not intended to be exhaustive or to limit the invention to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

What is claimed is:

1. A method comprising:
receiving, via a collection of write requests targeted to a non-volatile, solid-state memory, a first write request that is associated with a first logical address;
determining that the logical address is related to logical addresses of one or more other write requests of the collection that are not proximately ordered with the first write request in the collection; and
causing the first write request and the one or more other write requests to be written together to the memory.

2. The method of claim 1, wherein determining that the logical address is related to the logical addresses of the one or more other write requests of the collection comprises determining that the logical address is sequentially related to the logical addresses of the one or more other write requests of the collection.

3. The method of claim 1, further comprising:
associating each of a plurality of memory units with respective ranges of logical addresses; and
if the first logical address corresponds to a selected one of the ranges of logical addresses, assigning the first write request and the one or more other write requests to be written to a selected memory unit associated with the selected one of the ranges, otherwise assigning the first write request and the one or more other write requests to be written to a targeted memory unit using an alternate criteria.

4. The method of claim 3, further comprising searching the collection of write requests for the one or more other write requests in response to assigning the first write request to be written to the selected memory unit.

5. The method of claim 1, wherein the collection of write requests comprises a plurality of sequential streams of data.

6. The method of claim 5, further comprising:
maintaining mapping units between logical addresses of the sequential streams and physical addresses associated with targeted memory units in which the sequential streams are stored, wherein the mapping units comprise at least a start logical address and sequence length of an associated one of the sequential streams and a start logical address of a targeted memory unit in which the associated one sequential stream is stored; and
using the mapping units for servicing access requests for the targeted memory units in response to the logical addresses of the sequential streams being associated with the access requests.

7. The method of claim 1, wherein the collection comprises a cache, and wherein the first write request is received in response to a cache policy trigger that causes data of the first write request to be launched from the cache to the memory.

8. The method of claim 1, wherein causing the first write request and the one or more other write requests to be written together to the memory comprises causing the first write request and the one or more other write requests to be written sequentially to the memory.

9. The method of claim 1, wherein the first write request and the one or more other write requests are performed in response to garbage collection operations of an apparatus that includes the memory.

10. An apparatus comprising:
a controller that facilitates access to a non-volatile, solid-state memory, the controller configured to cause the apparatus to:
receive, via a collection of write requests targeted to the memory, a first write request that is associated with a first logical address;
determine that the logical address is related to logical addresses of one or more other write requests of the collection that are not proximately ordered with the first write request in the collection; and
cause the first write request and the one or more other write requests to be written together to the memory.

11. The apparatus of claim 10, wherein determining that the logical address is related to the logical addresses of the one or more other write requests of the collection comprises determining that the logical address is sequentially related to the logical addresses of the one or more other write requests of the collection.

12. The apparatus of claim 10 wherein the controller further causes the apparatus to:
associate each of a plurality of memory units with respective ranges of logical addresses; and
if the first logical address corresponds to a selected one of the ranges of logical addresses, assign the first write request and the one or more other write requests to be written to a selected memory unit associated with the selected one of the ranges, and otherwise assign the first write request and the one or more other write requests to be written to a targeted memory unit using an alternate criteria.

13. The apparatus of claim 12, wherein the controller further causes the apparatus to search the collection of write requests for the one or more other write requests in response to assigning the first write request to be written to the selected memory unit.

14. The apparatus of claim 10, wherein the collection of write requests comprises a plurality of sequential streams of data, and wherein the controller further causes the apparatus to:
maintain mapping units between logical addresses of the sequential streams and physical addresses associated with targeted memory units in which the sequential streams are stored, wherein the mapping units comprise at least a start logical address and sequence length of an associated one of the sequential streams and a start logical address of a targeted memory unit in which the associated one sequential stream is stored; and
use the mapping units for servicing access requests for the targeted memory units in response to the logical addresses of the sequential streams being associated with the access requests.

15. The apparatus of claim 10, further comprising one or more page builder modules operable via the controller, wherein each page builder module is associated with a) a logical address range and b) at least one page of the memory, wherein each of the page builder modules independently determine that the logical address of the first write request is sequentially related to the associated logical address ranges, and if so cause the first write request and the one or more other write requests to be written together to the associated at least one page.

16. The apparatus of claim 10, wherein the first write request and the one or more other write requests are performed in response to garbage collection operations of the apparatus.

17. An apparatus comprising:
a cache comprising a one or more sequential streams of data targeted for writing to a non-volatile, solid state memory;
a controller that causes the apparatus to:
associate each of a plurality of units of the memory with respective ranges of logical addresses;
receive, via the cache, a first write request that is associated with a first logical address;
determine that the first logical address is sequentially related to logical addresses of one or more other write requests of the cache that are not proximately ordered with the first write request in the cache;
determine that any of the first logical address and the logical addresses of the one or more other write requests correspond to a selected one of the ranges of logical addresses; and
cause the first write request and the one or more other write requests to be written sequentially to a unit of the memory associated with the selected one of the ranges of logical addresses in response thereto.

18. The apparatus of claim 17, wherein the controller further causes the apparatus to:
maintain mapping units between logical addresses of the sequential streams and physical addresses associated with the units of the memory in which the sequential streams are stored, wherein the mapping units comprise at least a start logical address and sequence length of an associated one of the sequential streams and a start logical address of a targeted unit of the memory in which the associated one sequential stream is stored; and
use the mapping units for servicing access requests for the targeted unit of memory in response to the logical addresses of the sequential streams being associated with the access requests.

19. The apparatus of claim 17, wherein the controller further comprises one or more page builder modules operable by the controller, wherein each page builder module is associated with a) one of the logical address ranges and b) at least one page of the memory, wherein each of the page builders independently determine that any of the first logical address and the logical addresses of the one or more other write requests correspond to the associated one logical address range, and if so cause the first write request and the one or more other write requests to be written sequentially to the associated at least one page.

20. The apparatus of claim 19, wherein the page builder modules comprise a plurality of page builder modules operating in parallel.
